(19) United States
(12) Patent Application Publication
(10) Pub. No.: US 2011/0226260 A1
(43) Pub. Date: Sep. 22, 2011

(54) Neurosurgical head holder in combination with a local coil

(76) Inventors: Hanns Eder, Bubenreuth (DE); Anke Weissenborn, Well am Rhein (DE)

(21) Appl. No.: 13/050,144

(22) Filed: Mar. 17, 2011

(30) Foreign Application Priority Data
Mar. 18, 2010 (DE) 10 2010 011 902.4

(51) Int. Cl. A61G 15/00

(52) U.S. Cl. 128/845

(57) ABSTRACT

A local coil positioning arrangement is proposed for positioning at least one local coil at an adjustable distance from a Mayfield head fixing arrangement. The local coil positioning arrangement has a local coil holder for accommodating a local coil and a fixing arrangement for fixing the local coil holder at an adjustable distance to the head fixing arrangement.

### CROSS REFERENCE TO RELATED APPLICATIONS

This application claims priority of German application No. 10 2010 011 902.4 filed Mar. 18, 2010, which is incorporated by reference herein in its entirety.

### FIELD OF THE INVENTION

The invention relates to a local coil positioning arrangement for use in an imaging system, especially a magnetic resonance tomography system.

### BACKGROUND OF THE INVENTION

Magnetic resonance devices (MRTs) for examination of objects or patients by magnetic resonance tomography are known for example from DE10314215B4.

MR local coils (for imaging of a region on the head) and a head fixing by means of a head holder (for keeping the head still during the MR examination) are used for MR imaging before or after a neurosurgical operation on a head of an animal or a human being. Internally-known neurosurgical head holders include local coils above and below the head. The examination technique is internally known in which, for intermediate checking during an operation, one or more local coils are placed on the head without direct fixing, whereby if necessary, by using a suitable procedure and for example covering the head with sterile foil covers etc., sterility and direct proximity of a local coil to the operation location on the opened-up head is made possible during an examination.

### SUMMARY OF THE INVENTION

The object of the present invention is to optimize fixing of coils and a head during an MRT examination. This object is achieved in each case by the features of the independent claim. Advantageous developments are specified in the dependent claims.

An inventive local coil positioning arrangement for positioning a local coil relative to a head fixing arrangement supports use of (especially Mayfield-type) head clamps for an MR recording of at least one MR image of a head, e.g. between two substeps of a head operation. Although the coils in this case do not necessarily rest directly on the head, such a design allows them to be in good proximity to the latter. Even with coils and holder elements reused several times, suitable design in such cases allows a very high demand for possible sterility in respect of an opened-up cranium and an ability to exchange coils to be met.

### BRIEF DESCRIPTION OF THE DRAWINGS

Further features and advantages of possible embodiments of the invention emerge from the description of exemplary embodiments given below, which refer to the drawing. The drawings show:

FIG. 1 a schematic cross-section of a local coil positioning arrangement for positioning a local coil relative to a head fixing arrangement,

FIG. 2 a schematic diagram of an MRT system at least known internally per se.

### DETAILED DESCRIPTION OF THE INVENTION

Background:

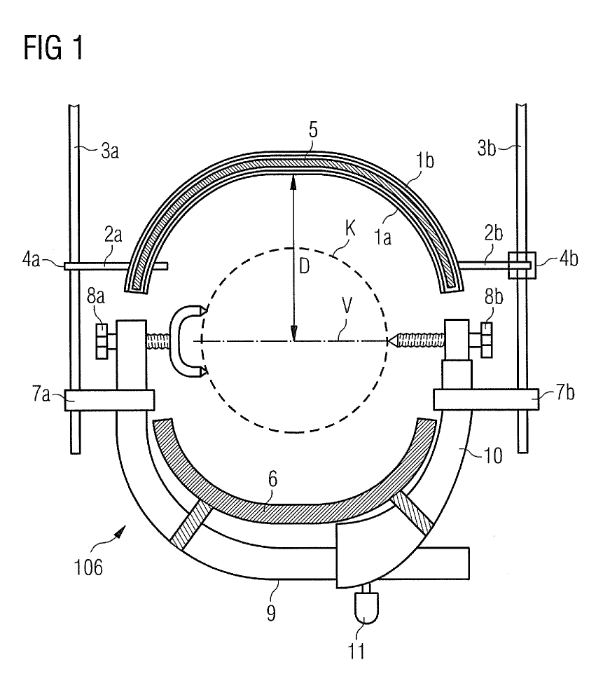

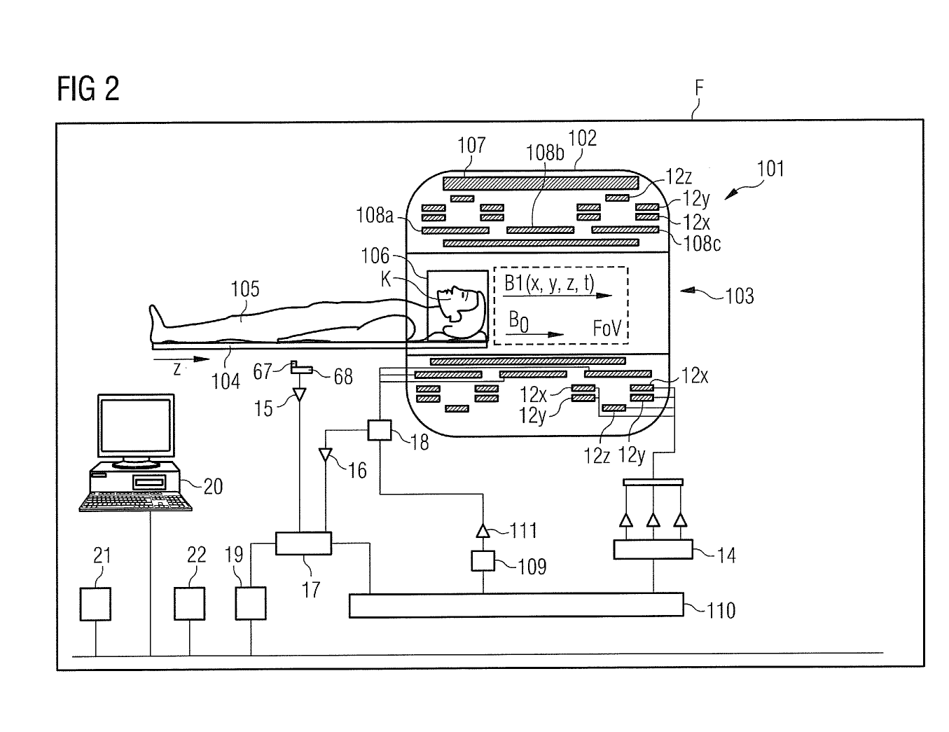

To illustrate the thematic background, FIG. 2 shows an imaging magnetic resonance device MRT 101 with a whole-body coil 102 with a space 103 which is tubular here, into which a patient bed 104 with a body of for example a patient 105 (usually with a local coil positioning arrangement 6) can be moved in the direction of the arrow z in order to generate images of the patient 105. Laid on the patient 105 here is a local call positioning arrangement 106 (shown in detail in FIG. 1) with which, when the patient 105 is pushed, in FIG. 2 in the direction z into the FoV (field of view), images of a local area (e.g. of the head K) can be recorded. Signals of the local coil positioning arrangement 106 can be evaluated by an evaluation device (67, 66, 15, 17, etc.) of the MRT 101 able to be connected via coaxial cable or wirelessly to the local coil positioning arrangement 106 (e.g. converted into images and stored or displayed).

In order to examine a body 105 (an object under examination or a patient) with a magnetic resonance device MRT 101 using magnetic resonance imaging, different magnetic fields exactly matched to each other in their temporal and spatial characteristics are directed into the body 5. A strong magnet, often a cryomagnet 107, in a measurement compartment, here with a tunnel-shaped opening 3, generates a statically-strong main magnetic field B₀typically amounting to between 0.2 Tesla and 3 Tesla or even more. A body 105 to be examined is supported on a patient bed 104 and is moved into a roughly homogeneous region of the main magnetic field B0 in the Field of View (FoV). The nuclear spins of atomic nuclei of the body 5 are excited via magnetic radio-frequency excitation pulses which are beamed in via a radio-frequency antenna shown here in very simplified form as a body coil 108 (and/or if necessary a local coil array). Radio-frequency excitation pulses are generated for example by a pulse generation unit 109 which is controlled by a pulse sequence control unit 110. After amplification by a radio-frequency amplifier 111 they are directed to the radio-frequency antenna 108a, b, c. The radio-frequency system shown here is merely indicated schematically. Often more than one pulse generation unit 109, more than one radio-frequency amplifier 111 and a number of radio-frequency antennas 108a, b, c are used in a magnetic resonance device 101.

In addition the magnetic resonance device 101 has gradient coils 12x, 12y, 12z with which magnetic gradient fields for selective slice excitation and for local encoding of the measurement signal are beamed in during a measurement. The gradient coils 12x, 12y, 12z are controlled by a gradient coil control unit 14 which, like the pulse generation unit 9, is connected to the pulse sequence control unit 110.

The signals sent out from excited nuclear spins are received by the body coils 108a, 108b, 108c and/or at least one local coil positioning arrangement 106, are amplified by assigned radio-frequency amplifiers 16 and are further processed and digitized by a receive unit 17. The recorded measurement data is digitized and is stored as complex numerical values in a k-space matrix. An associated MR image is able to be reconstructed by means of a multidimensional Fourier transformation from the k-space matrix occupied by values.

For a coil which can be operated both in transmit and also in receive mode, such as the body coils 108a, b, c, the correct signal forwarding is regulated by an upstream transmit-receive switch 18.

An image processing unit 19 generates an image from the measurement data, which is displayed to a user via an operating console 20 and/or is stored in a memory unit 21. A central processing unit 22 controls the individual system components.

In MR tomography images with a high signal-to-noise ratio (SNR) are nowadays generally recorded with so-called local coil arrays (coils, local coils). These are antenna systems which are attached in the immediate vicinity on (anterior) or below (posterior) or in the body. For an MR measurement the excited nuclei induce a voltage in the individual antennas of the local coil which is then amplified by a low noise pre-amplifier (e.g. LNA, preamp) and is finally forwarded to the receive electronics. To improve the signal-to-noise ratio even with high-resolution images, so-called high-field systems are employed (1.5 T and more). Since a number of individual antennas which are present as receivers can be connected to an MR receive system, a switching matrix (referred to here as RCCS) is integrated between receive antennas and receiver. This routes the currently active receive channels (mostly those which lie right in the field of view of the magnet) to the available receivers. This makes it possible to connect a number of coil elements which are present as receivers, since for whole-body coverage only the coils have to be read out which are located in the FoV (field of view) or in the homogeneity volume of the magnet.

An antenna system is generally referred to here as a local coil positioning arrangement 6, which for example can consist of one antenna element or as an array coil of a number of antenna elements (especially coil elements). These individual antenna elements are embodied for example as loop antennas (loops), butterfly or saddle coils. A local coil positioning arrangement typically comprises coil elements, a preamplifier, further electronics (baluns, etc.), a housing, supports and mostly a cable with a plug through which it is connected to the MRT system. A receiver 68 attached to the system side filters and digitizes a signal received by radio from a local coil 106 for example and transfers the data to a digital signal processing system which generally derives an image or a spectrum from the data obtained by the measurement and makes it available to the user, for subsequent diagnosis by them or storage for example.

As an exemplary embodiment of the invention, FIG. 1 shows a schematic cross-sectional diagram of a local positioning arrangement 106 for positioning a local coil 5 relative to a head fixing arrangement 8a, 8b, 9, 10, 11 and thereby to a head K.

MR imaging of a head K is to be undertaken. Not only but typically this can for example be a checking intermediate step between two phases (e.g. tumor removal, MR imaging check, if necessary precise tumor residue removal) of a neurosurgical operation on a head of an animal or a human being. An MRT image can also be recorded before an operation for example.

The invention comprises a positioning and fixing of one or more local coils 5 above (and expediently also below=reference character 6) the head K of a patient or animal (indicated by a dashed line) in combination with a Mayfield clamp-like head fixing 8a, 8b, 9, 10, 11. Such a Mayfield clamp-like head fixing 8a, 8b, 9, 10, 11 can for example have two shell parts 9, 10 which are able to be moved in relation to each other to accommodate different sizes of head K and are able to be fixed to each other by a fixing screw 11.

A fixing of a head with a Mayfield clamp-like head fixing 8a, 8b, 9, 10, 11 can consist, expressed in simple terms of pressing or slightly pressing onto a head to be fixed (expediently under a general or local anesthetic) two or more adjustment means such as the adjustment screws 8a, 8b (with stainless steel pins at the tips for example).

A Mayfield-type head clamp 8a, 8b, 9, 10, 11 allows surgical flexibility in the support of the patient, a positioning of local coils in a suitable position sufficiently close to a field of view (FoV) in the head K of the patient and a good image quality.

MR-compatible versions of Mayfield-type head clamps can be used for the neurosurgical operations. There are attachment options 7a, 7b for various accessories on the Mayfield-type head clamps. For an MRT image before or after an operation or between two parts of operation the patient can remain in a Mayfield-type head clamp in which he is also located during the operation. One or more local coils can be positioned over the patient with a local coil positioning arrangement for MRT imaging, with said local coils and/or local coil positioning arrangement able to remain there after an MRT image has been recorded during an operation or able to be removed.

The invention comprises a development of a suitable attachment option for one or more flexible local coils 5 (e.g. a coil for which the conductor tracks are attached to a film and these as well as the amplifier are embedded in a foam) on Mayfield-type head clamps (8a, 8b, 8c, 10, 11). The attachment facility is embodied from MR-compatible material. The material is expediently able to be sterilized since the local coil and holder can be located in the region of a surgically-opened head. Such materials are used for example as retaining bars and clamps (2a, 2b, 3a, 3b, 4a, 4b, etc.).

A local coil holder 1a, 1b to accept a local coil 5 in this case comprises two holder parts in the form of shells 1a, 1b for example, which is typically connected by two connection elements in the form of rods 2a, 2b (e.g. each with a thread and with nuts not shown in the figure on both sides of the shells in order to press the shells 1a, 1b together). These rods 2a, 2b are in their turn supported by two distancing elements in the form of rods 3a, 3b via two simple-to-open, releasable attachment elements in the form of connecting clamps 4a, 4b. E.g. by selecting the height at which the attachment clamps 4a, 4b will be attached, the distance of the local coil holder is thus height-adjustable relative to the head K.

The distancing elements in the form of rods 3a, 3b hold a local coil 5 at a selectable distance D from a head or at a distance D to a connecting line V of the two head-fixing screws 8a, 8b (between which a head can be inserted).

The rods 3a, 3b are attached via two releasable attachment elements in the form of attachment clamps 7a, 7b to the Mayfield head clamp 9, 10.

The fixing arrangement 4a, 4b to set the distance D of the coil holder 1a, 1b to the head fixing arrangement 8a, 8b, 9, 10, 11 (i.e. in FIG. 1 to set how far a coil 5 is above a head or the head fixing screws 8a, 8b) can, as here, consist of the rods 2a, 2b being clamped to two distancing elements in the form of rods 3a, 3b over to simple-to-open, releasable connecting clamps 4a, 4b in the desired position (and thus at a prespecified or desired distance D). Other and/or more complex movement mechanisms, etc. for setting the distance D are also conceivable if necessary.

This construction enables Mayfield clamps to be used efficiently in a neurosurgical, inter-operative area of application supported by MR imaging with their advantages (such as if necessary generous free space for the surgeons for example). The local coil holder for a local coil is able to be removed at any time and can be attached in the same position again at any time. This means that it is relatively simple for example for coils to be used in the inter-operative area (e.g. between two operation steps) which already exist and are in widespread use but previously are only used in a purely diagnostic application; for sterilization of the coils these are then packed into drapes or sleeves for example. The upper part and the lower part 1a, 1b of a local coil holder of the coil 5 is able to be removed easily and quickly at any time. The positioning of the coil(s) 5 has a great degree of freedom through this solution. The holder and thereby the coils are height-adjustable over a very wide range. It consists of two spatially-separated units and is able to be dismantled (advantageously for the sterilization concept and the insertion of the coils).

As well as the local coil 5 in the local coil holder 1a, 1b, a further local coil 6 is provided here which is located below a head K when the latter is held in the head fixing arrangement (screws 8a, 8b, etc.). The arrangement thus allows images to be recorded with local coils above and below the head. A local coil holder of the further local coil 6 below the head K can for example also be designed in two pieces with two shells so that the local coil 6 can be easily replaced. A local coil holder (or its lower part) of the further local coil(s) 6 is attached for example to the Mayfield clamp 9, 10 with adjustment screws or rods.

1-15. (canceled)

16. A local coil positioning arrangement, comprising:
a local coil for imaging a head of a patient;
a local coil holder for accommodating the local coil;
a head fixing arrangement for keeping the head of the patient still; and
a fixing arrangement for fixing the local coil holder at an adjustable distance from the head fixing arrangement.

17. The local coil positioning arrangement as claimed in claim 16, wherein the local coil holder comprises at least two holder parts between which the local coil is fixed.

18. The local coil positioning arrangement as claimed in claim 17, wherein the at least two holder parts are two shells.

19. The local coil positioning arrangement as claimed in claim 17, wherein the at least two holder parts are connected to each other by connecting elements.

20. The local coil positioning arrangement as claimed in claim 19, wherein the connecting elements are rods.

21. The local coil positioning arrangement as claimed in claim 19, further comprising distancing elements extending entirely or partly in parallel to a direction of the adjustable distance.

22. The local coil positioning arrangement as claimed in claim 21, wherein the distancing elements are able to be fixed to the connecting elements in a number of positions.

23. The local coil positioning arrangement as claimed in claim 22, wherein the distancing elements are able to be fixed to the connecting elements by releasable attachment devices.

24. The local coil positioning arrangement as claimed in claim 21, wherein the distancing elements are attached to the head fixing arrangement by releasable attachment devices.

25. The local coil positioning arrangement as claimed in claim 16, wherein the head fixing arrangement comprises at least two shell parts that are able to be moved relative to each other and are able to be fixed to each other by a fixing device.

26. The local coil positioning arrangement as claimed in claim 16, wherein the head fixing arrangement comprises adjustment devices.

27. The local coil positioning arrangement as claimed in claim 16, wherein the head fixing arrangement is a Mayfield head fixing arrangement.

28. The local coil positioning arrangement as claimed in claim 16, wherein the local coil is packed into an envelope.

29. The local coil positioning arrangement as claimed in claim 16, further comprising a further local coil that is fixed to the head fixing arrangement.

30. The local coil positioning arrangement as claimed in claim 29, wherein the further local coil is packed into an envelope.

31. The local coil positioning arrangement as claimed in claim 16, wherein the local coil positioning arrangement consists of an MR-compatible material.
